(19) United States
(12) Patent Application Publication
(10) Pub. No.: US 2026/0244192 A1
(43) Pub. Date: Aug. 20, 2026

(54) SYSTEMS AND METHODS FOR RESOURCE ALLOCATION

(71) Applicant: IMPERATIVE EXECUTION INC., Stamford, CT (US)

(72) Inventor: Roman Ginis, Glenbrook, NV (US)

(73) Assignee: IMPERATIVE EXECUTION INC., Stamford, CT (US)

(21) Appl. No.: 19/543,818

(22) Filed: Feb. 18, 2026

Related U.S. Application Data
(60) Provisional application No. 63/759,614, filed on Feb. 18, 2025.

(51) Int. Cl. G05B 19/418

(52) U.S. Cl. CPC G05B 19/41835; G05B 19/4183; G05B 19/4187

(57) ABSTRACT

Systems and methods for allocating operational resources to achieve a target average utility goal.

### PRIORITY CLAIM

This application claims priority to U.S. Provisional Application No. 63/759,614, filed Feb. 18, 2025, entitled SYSTEMS AND METHODS FOR RESOURCE ALLOCATION, the contents of which are hereby incorporated herein by reference.

### FIELD OF THE INVENTION

The present invention relates to resource allocation control systems.

### BACKGROUND

Efficient resource allocation is a critical consideration in the operation of industrial systems. Such systems are typically composed of interconnected machines implementing different processes and consuming particular resources. Optimizing the operation of such systems often presents the challenge of distributing limited resources, such as energy and raw materials among different pieces of equipment to perform the same, similar, or different operations. The complexity of this problem increases as the scale of the industrial system expands with different pieces of equipment having different rates and qualities of outputs, different resource utilizations, different efficiencies, and different operational costs.

Traditional resource allocation methods in industrial environments may rely on human decision-making or static rule-based systems. Static approaches may lack the flexibility to adapt to real-time changes in demand, process variability, or resource availability. As a result, operational inefficiencies may arise, leading to reduced throughput, delays in output, and increased costs.

### SUMMARY OF THE INVENTION

A common scenario in industrial systems involves a group of fixed-output equipment, such as machines or production units, which have differing predefined production rates. In such systems, it can be a challenge to allocate available resources among the fixed-output units in an optimized manner. Without optimized allocation, certain equipment may be underutilized resulting in lost opportunities for production, while other equipment may be overutilized resulting in production bottlenecks or requiring additional maintenance, expensive replacement, and unnecessary downtime. Ultimately, overall system efficiency and resiliency may be reduced.

Given the generally fixed nature of output in certain pieces of equipment, there is a need for advanced allocation systems and methodologies that coordinate the utilization of limited resources to achieve predictable and reliable outputs in response to varying requirements. Such a system considers both the limitations of individual resources and the overall system constraints. An optimal resource allocation methodology preferably distributes resources and output requirements across all fixed-output units, thereby maximizing productivity and minimizing downtime.

With advancements in computational models, real-time monitoring, and optimization algorithms, a more dynamic and efficient methodology can allocate resources in industrial systems in an adaptive manner. The system leverages predictive capabilities, data-driven insights, and automated decision-making to optimize production distribution across multiple items of equipment, thereby enhancing overall system productivity and minimizing waste. Suboptimal performance, resource wastage, or downtime are to be avoided.

In various industries, there exists a need to optimally allocate a limited supply of production resources to meet a specific demand while adhering to constraints of production capacity, demand, and average utilization. As an example, a manufacturing system comprising multiple machines with different output rates and production costs can be managed to meet a particular demand with targeted average utilization for the group of machines. As another example, data centers offering cloud computing services preferably allocate computing resources to clients while managing to achieve an average power consumption within a cost-efficient range and practical power generation limitations. Similarly, in securities trading, securities orders for a given security may be allocated for execution at different price levels to achieve a target average price. Other applications include inkjet printing with variable droplet sizes, medication dosing with discrete pill sizes, and engine valves with multiple opening distances.

Current systems lack a generalized solution for allocating supply to demand under an average rate constraint, especially when dealing with discrete supply units and dynamic conditions. The calculation engine of the present invention can efficiently compute the optimal allocation of supply units to meet the demand while satisfying a target average constraint. In further embodiments, the calculation engine accommodates changes in supply availability and provides estimates when exact solutions are computationally intensive.

A supply to demand allocation calculation engine has been developed that computes an optimal allocation of discrete supply units to meet a specified demand under a target average utility constraint. The calculation engine solves for the allocation weights of supply units, each with distinct utility levels, to achieve, or at least approximate, the desired average utility rate. The calculation engine utilizes algorithms based on linear algebra to determine the allocation weights. It also may accommodate dynamic supply and demand conditions, recalculate allocations when certain supply units become unavailable, and provide estimation algorithms for scenarios where production tradeoffs are acceptable, e.g., speed is prioritized over cost. The engine also handles infeasible scenarios by suggesting adjustments to the target average constraint or indicating the impossibility of meeting the demand under current constraints.

The present invention provides an improved methodology for resource allocation in industrial systems to efficiently allocate resources based on real-time demand, production parameters, and system conditions, particularly in scenarios involving fixed-output equipment. Potential applications of the calculation engine span many fields, including manufacturing systems, data center resource allocation, inkjet printing, medication dosing, mechanical position systems, securities trading systems, and the like.

According to an aspect of the invention, an operation resource allocation control system includes a plurality of operation parameter data sources providing a respective plurality of operation parameter data; an operation demand data source providing an operation demand data; a target average utility data source providing a target average utility goal; a control system, comprising an operation allocation calculation engine, coupled to the plurality of operation parameter data sources, the operation demand data source, and the target average utility data source; an operation system, coupled to the control system and having a plurality of resource inputs and an operation output, includes a plurality of operation units, wherein each operation unit has a respective operation rate; a plurality of resources coupled to the plurality of resource inputs; and an output detector coupled to the operation output and to the control system; wherein the control system throttles the respective operation rates of the plurality of operation units to meet the target average utility goal, based on the plurality of operation parameter data, the operation demand data, and the target average utility goal.

According to an aspect of the invention, an operation resource allocation control method includes the steps of: receiving a plurality of operation parameter data, an operation demand data, and a target average utility goal; calculating a plurality of operation rate allocations to achieve the target average utility goal, based on the plurality of operation parameter data, the operation demand data, and the target average utility goal; communicating, respectively, the plurality of operation rate allocations to a plurality of operation equipment; operating each of the plurality of operation equipment in accordance with a respectively corresponding one of the plurality of operation rate allocations; detecting a plurality of respective output values for the plurality of operation equipment; and determining an average utility value based on the plurality of respective output values.

### DESCRIPTION OF THE DRAWINGS

FIG. 1 shows a block diagram of an industrial system according to an embodiment of the present invention.

FIG. 2 shows a block diagram of a computer system according to an embodiment of the present invention.

FIG. 3 illustrates the positioning of a valve piston controlled by a control system according to an embodiment of the present invention.

FIG. 4 illustrates an ink jet print head array controlled by a control system according to an embodiment of the present invention.

FIG. 5 illustrates a medication tablet and portions thereof to be allocated by a control system according to an embodiment of the present invention.

FIG. 6 is a flow diagram of a method for allocating resources according to an embodiment of the present invention.

FIG. 7 shows an algorithm for allocating resources according to an embodiment of the present invention.

FIG. 8 shows an example of an allocation calculation for a data center computer system according to an embodiment of the present invention.

### DETAILED DESCRIPTION OF THE INVENTIONS

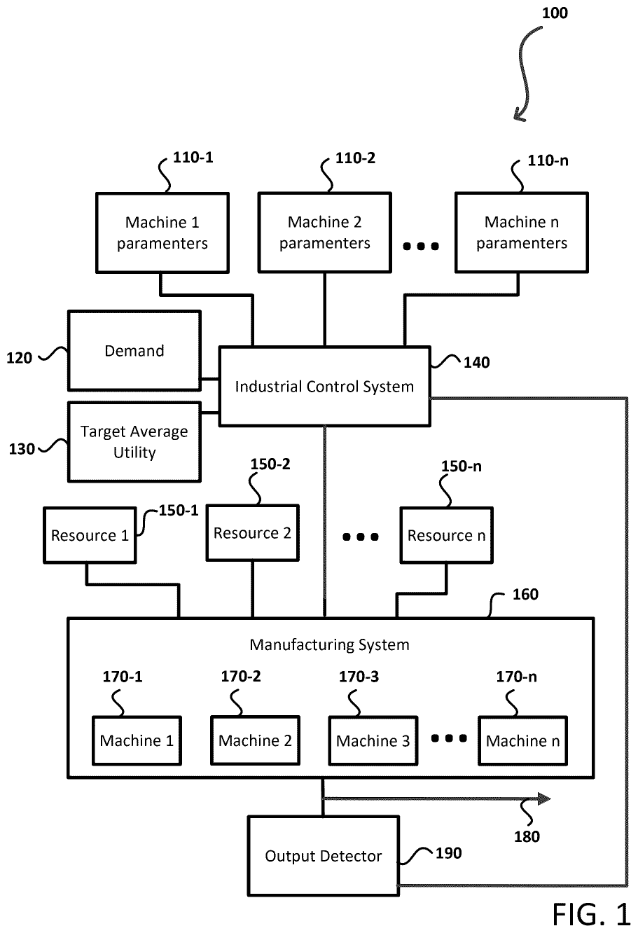

In FIG. 1, a block diagram of an industrial system 100 is shown. System 100 comprises machine parameter source 110-1 through machine parameter source 110-n, demand source 120, target average utility source 130, industrial control system 140, resource sources 150-1 through resource source 150-n, manufacturing system 160, and output detector 190. Manufacturing system 160 includes machine 170-1 through machine 170-n. Each of machine parameter sources 110-1, 110-2, . . . , and 110-n; demand source 120; and target average utility source 130 is coupled to industrial control system 140. Each of resource sources 150-1, 150-2, . . . , and 150-n is coupled to manufacturing system 160. Output detector 190 is coupled to manufacturing system 160 and receives output 180. Output detector 190 is coupled to industrial control system 140 and provides information regarding output 180, e.g., feedback signals, to industrial control system 140.

Machine parameter source 110-1 through machine parameter source 110-n provide to industrial control system 140 one or more operating parameters for corresponding machine 170-1 through machine 170-n. Preferably, there is a one-to-one correspondence between the number of machine parameter sources and the number of machines. For example, machine parameter source 110-2 provides to industrial control system 140 particular operating parameters for machine 2 170-2. Operating parameters may include, but are not limited to, resource consumption, output quantity, output rate, output characteristic, output price, output quality, waste production, maintenance schedule, or the like. The machine parameter sources may comprise a user interface, a communications interface, a computer implementing an algorithm, a signal generator, a storage device, a feedback signal from the corresponding machine, an aggregated signal from multiple machines, a signal from output detector 190 (not shown), or the like. Resource consumption may include, but is not limited to, raw material consumption, electric power consumption, lubricant consumption, component wear, maintenance time and cost, or the like.

Demand source 120 provides a demand value to industrial control system 140. The demand value may preferably be output quantity, output rate, output completion time, output characteristic, output price, and/or output quality, or the like of manufacturing system 160. The demand value may be static or dynamic, and may change due to different resource values from one or more of resources 1, 2, . . . , and n. Demand source 120 may comprise a user interface, a communications interface, a computer implementing an algorithm, a signal generator, a storage device, a signal from output detector 190 (not shown), or the like. In an alternate embodiment, the demand value may include resource consumption and/or waste production, or the like. In a further alternate embodiment, the demand value may include the static or dynamic cost of one or more of resources 1, 2, . . . , and n.

Target average utility source 130 provides a target average utility value to industrial control system 140. The target average utility value may preferably be output quantity, output rate, output completion time, output characteristic, output price, and/or output quality, or the like of manufacturing system 160. The target average utility value may be static or dynamic, and may change due to external factors such as an output quantity requirement, an output rate requirement, an output completion time deadline, an output characteristic change, an input price change, an output price requirement, an output quality change, an input resource change, a resource consumption requirement, a waste production limit, or the like. Target average utility source 130 may comprise a user interface, a communications interface, a computer implementing an algorithm, a signal generator, a storage device, a signal from output detector 190 (not shown), or the like.

Industrial control system 140 is a control system for allocating the production of products by the constituent machines in manufacturing system 160 to meet the demand value, provided by demand source 120, while meeting the target average utility value, provided by target average utility source 130. Industrial control system 140 comprises a computing system implementing an allocation algorithm for calculating an allocation for operating two or machines 170-1 . . . 170-n based on the respective operating parameters for those machines, the demand value, and the target average utility value.

Preferably, industrial control system 140 sends control signals corresponding to the determined allocation to manufacturing system 160 to control the operations of machines 170-1 . . . 170-n individually. Such control signals may comprise for each machine, or combinations thereof, on/off signals, production rate control signals, power usage control signals, or the like. Alternatively, industrial control system 140 may operate machines 170-1 . . . 170-n in groups. By controlling the operations of machines 170-1 . . . 170-n, industrial control system 140 controls the aggregate output of manufacturing system 160 to attain, or at least approximate, the target average utility value.

Preferably, industrial control system 140 also adjusts the allocation of operations among machines 170-1 . . . 170-n based on a detected or estimated average utility value. Industrial control system 140 may itself calculate an average utility value based on operational results detected by output detector 190. Alternatively, industrial control system 140 receives an average utility value from output detector 190.

Optionally, industrial control system 140 also calculates a particular timing for operating the machines 170-1 . . . 170-n to implement the calculated allocation.

Industrial control system 140 may be implemented with conventional hardware programmed with the inventive algorithm of the present invention. Such hardware includes a software-controlled industrial controller, a programmable computer, a programmable processor, a programmable cloud server computer with storage device, a distributed network of programmable computing devices, an ASIC implementing the algorithm, a programmed gate array implementing the algorithm, or the like.

Each of resource source 150-1, resource source 150-2, . . . , and resource source 150-n provides a corresponding resource 1, resource 2, . . . , and resource n. Resource 1, resource 2, . . . , and resource n are preferably different resources and, alternatively, may be different sources of the same resource, or different portions of a source of the same resource. Resources may include raw materials, electric power, lubricants, manufacturing consumables (e.g., finite life parts, dies, molds, and the like), maintenance consumables (e.g., spare parts, replaceable parts, and the like), or the like. Resource 1, resource 2, . . . , and resource n are preferably limited resources having a finite amount, capacity, and/or delivery rate and, alternatively, are unlimited resources.

Manufacturing system 160 is preferably a system for manufacturing products incorporating at least two machines: machine 170-1 and machine 170-2. Alternatively, manufacturing system 160 may include up to n machines: machine 170-1, machine 170-2, machine 170-3, . . . , and 170-n. For ease of reference, each of machines 170-1, 170-2, 170-3, . . . , and 170-n are shown in FIG. 1 comprising respectively corresponding machine 1, machine 2, machine 3, . . . , and machine n.

Outputs from each of machines 170-1 . . . 170-n preferably comprise the output from manufacturing system 160 at output 180. Output 180 may include outputs from machines 170-1 . . . 170-n in a serial order, a parallel order, a randomized order, a particular algorithmic order, or the like. Alternatively, the outputs of machines 170-1 . . . 170-n are combined with one or more of each other to produce output 180. Such combination may include aggregating, weighted aggregating, averaging, weighted averaging, or the like, of the individual outputs of machines 170-1 . . . 170-n.

Output detector 190 detects the output of manufacturing system 160. Output detector 190 may be implemented as a dedicated sensor, a programmed processor, a programmed computer, or the like. Preferably, output detector 190 may detect the individual outputs of each of machines 170-1, 170-2, . . . , 170-n. It is further preferred that output detector 190 calculates an average utility value. Output detector 190 may send the detected individual outputs and/or the calculated average utility value to industrial control system 140. Output detector 190 also may provide to a user via a user interface (not shown) a confirmation signal (e.g., a green light, bell sound, check mark symbol, or the like), an incomplete signal (e.g., a red light, buzzer sound, x symbol, or the like), a list of operations, a summary report of operations, an aggregate result of operations, or an average utility value. In an alternate embodiment, output detector 190 is omitted.

In a further alternate embodiment, manufacturing system 160 comprises a single machine 170-1 which is capable of adjustable modes of operation corresponding to machine 1 parameters 110-1 and machine 2 parameters 110-2. For example, machine 170-1 may have a “high speed” mode that produces products at a higher rate with more electric power and a “low speed” mode that produces products at a lower rate with less electric power and is more energy efficient.

In a preferred embodiment, system 100 includes at least two machine parameter sources and two machines: machine 1 parameter source 110-1 and machine 2 parameter source 110-2 corresponding to machine 170-1 and machine 170-2, respectively. In a preferred operation, industrial control system 140 utilizes the parameters provided by machine 1 parameter source 110-1 and machine 2 parameter source 110-2, the demand amount provided by demand source 120, and the target average utility amount provided by target average utility source 130 to determine an allocation of operations for each of machine 170-1 and machine 170-2. Industrial control system 140 sends control signals corresponding to the determined allocation to manufacturing system 160 to control the operations of machine 170-1 and machine 170-2 to achieve, or at least approximate, the target average utility value.

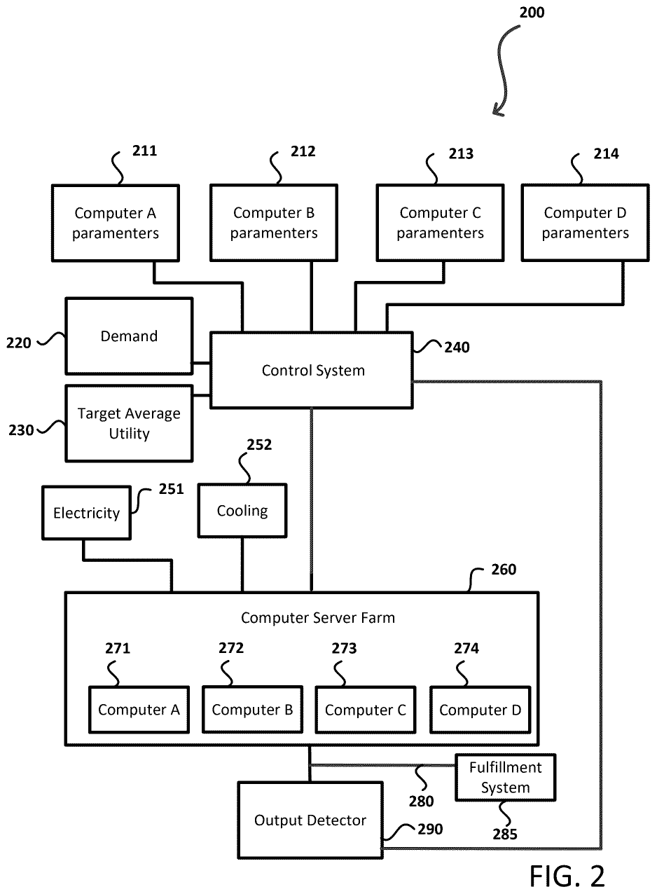

FIG. 2 shows a computer system 200 according to an embodiment of the present invention. System 200 comprises computer A parameters source 211, computer B parameters source 212, computer C parameters source 213, computer D parameters source 214, demand source 220, target average utility source 230, control system 240, electricity source 251, cooling source 252, computer server farm 260, fulfillment system 285, and output detector 290. Computer server farm 260 includes computer A 271, computer B 272, computer C 273, and computer D 274.

Each of computer A parameters source 211, computer B parameters source 212, computer C parameters source 213, computer D parameters source 214, demand source 220, and target average utility source 230 is coupled to control system 240. Each of electricity sources 251 and cooling source 252 is coupled to computer server farm 260. Output detector 290 is coupled to computer server farm 260 and receives output 280. Output detector 290 is coupled to control system 240 and provides information regarding output 280, e.g., feedback signals, to control system 240. Output 280 is also provided to fulfillment system 285 which, preferably, operates to implement the actions directed by computer server farm 260.

In a preferred embodiment, computer A parameters source 211 provides to control system 240 particular operating parameters for computer A 271; computer B parameters source 212 provides to control system 240 particular operating parameters for computer B 272; computer C parameters source 213 provides to control system 240 particular operating parameters for computer C 273; and computer D parameters source 214 provides to control system 240 particular operating parameters for computer D 274. Operating parameters may include, but are not limited to, resource consumption such as electricity consumption or cooling consumption, output quantity, output rate, output characteristic, output price, output quality, maintenance schedule, or the like. The computer parameters sources may comprise a user interface, a communications interface, a computer implementing an algorithm, a signal generator, a storage device, a feedback signal from the corresponding computer, an aggregated signal from multiple computers, a signal from output detector 290, or the like. Resource consumption may include, but is not limited to, data storage usage, data consumption, electric power consumption, cooling consumption, maintenance time and cost, or the like.

Demand source 220 provides a demand value to control system 240. The demand value may preferably be output quantity, output rate, output completion time, output characteristic, output price, and/or output quality, or the like of computer server farm 260. The demand value may be static or dynamic, and may change due to different resource values, e.g., from one or more of electricity resource 251 or cooling resource 252, or from other resources. Demand source 220 may comprise a user interface, a communications interface, a computer implementing an algorithm, a signal generator, a storage device, a signal from output detector 290, or the like. In an alternate embodiment, the demand value may include resource consumption and/or waste production, or the like. In a further alternate embodiment, the demand value may include the static or dynamic cost of one or more resources.

Target average utility source 230 provides a target average utility value to control system 240. The target average utility value may preferably be output quantity, output rate, output completion time, output characteristic, output price, and/or output quality, or the like of computer server farm 260. The target average utility value may be static or dynamic, and may change due to external factors such as an output quantity requirement, an output rate requirement, an output completion time deadline, an output characteristic change, an input price change, an output price requirement, an output quality change, an input resource change, a resource consumption requirement, a waste production limit, or the like. Target average utility source 230 may comprise a user interface, a communications interface, a computer implementing an algorithm, a signal generator, a storage device, a signal from output detector 290, or the like.

Control system 240 is a control system for allocating the computational operations of the constituent computers in computer server farm 260 to meet the demand value, provided by demand source 220, while meeting the target average utility value, provided by target average utility source 230. Control system 240 comprises a computing system implementing an allocation algorithm for calculating an allocation for operating two or more of computer A 271, computer B 272, computer C 273, and computer D 274 based on the respective operating parameters for those computers, the demand value, and the target average utility value.

Preferably, control system 240 sends control signals corresponding to the determined allocation to computer server farm 260 to control the operations of computer A 271, computer B 272, computer C 273, and computer D 274, individually. Such control signals may comprise for each computer, or combinations thereof, on/off signals, rate control signals, power usage control signals, or the like. Alternatively, control system 140 may operate computer A 271, computer B 272, computer C 273, and computer D 274 in groups. By controlling the operations of computers computer A 271, computer B 272, computer C 273, and computer D 274, control system 240 controls the aggregate output of computer server farm 260 to attain, or at least approximate, the target average utility value.

Preferably, control system 240 also adjusts the allocation of operations among computer A 271, computer B 272, computer C 273, and computer D 274 based on a detected or estimated average utility value. Control system 240 may itself calculate an average utility value based on operational results detected by output detector 290. Alternatively, control system 240 receives an average utility value from output detector 290.

Optionally, control system 240 also calculates a particular timing for operating computer A 271, computer B 272, computer C 273, and computer D 274 to implement the calculated allocation.

Control system 240 may be implemented with conventional hardware programmed with the inventive algorithm of the present invention. Such hardware includes a software-controlled industrial controller, a programmable computer, a programmable processor, a programmable cloud server computer with storage device, a distributed network of programmable computing devices, an ASIC implementing the algorithm, a programmed gate array implementing the algorithm, or the like.

Electricity source 251 provides electric power. Cooling source 252 provides temperature cooling, e.g., air conditioning, fan control, air circulation, or the like. Optionally, either electricity source 251 or cooling source 252 may be omitted or replaced with other resources, inputs, consumables, or the like. Electricity source 251 and cooling source 252 are preferably limited resources having a finite amount, capacity, and/or delivery rate and, alternatively, are unlimited resources.

Outputs from each of computer A 271, computer B 272, computer C 273, and computer D 274 preferably comprise the output from computer server farm 260 at output 280. Output 280 may include outputs from computer A 271, computer B 272, computer C 273, and computer D 274 in a serial order, a parallel order, a randomized order, a particular algorithmic order, or the like. Alternatively, the outputs of computer A 271, computer B 272, computer C 273, and computer D 274 are combined with one or more of each other to produce output 280. Such combination may include aggregating, weighted aggregating, averaging, weighted averaging, or the like, of the individual outputs of computer A 271, computer B 272, computer C 273, and computer D 274.

Output detector 290 detects the output of computer server farm 260. Output detector 290 may be implemented as a dedicated sensor, a programmed processor, a programmed computer, or the like. Preferably, output detector 290 may detect the individual outputs of each of computer A 271, computer B 272, computer C 273, and computer D 274. It is further preferred that output detector 290 calculates an average utility value. Output detector 290 may send the detected individual outputs and/or the calculated average utility value to control system 240. Output detector 290 also may provide to a user via a user interface (not shown) a confirmation signal (e.g., a green light, bell sound, check mark symbol, or the like), an incomplete signal (e.g., a red light, buzzer sound, x symbol, or the like), a list of operations, a summary report of operations, an aggregate result of operations, or an average utility value. In an alternate embodiment, output detector 290 is omitted.

In a further alternate embodiment, computer server farm 260 comprises a single computer A 271 which is capable of adjustable modes of operation corresponding to computer parameters A 211 and computer B parameters 212. For example, computer A 271 may have a “high speed” mode that computes at a higher rate with more electric power and a “low speed” mode that computes at a lower rate with less electric power and is more energy efficient.

In a preferred operation, control system 240 utilizes the parameters provided by computer A parameters source 211, computer B parameters source 212, computer C parameters source 213, computer D parameters source 214, the demand amount provided by demand source 220, and the target average utility amount provided by target average utility source 230 to determine an allocation of operations for each of computer A 271, computer B 272, computer C 273, and computer D 274. Control system 240 sends control signals corresponding to the determined allocation to computer server farm 260 to control the operations of computer A 271, computer B 272, computer C 273, and computer D 274 to achieve, or at least approximate, the target average utility value.

Fulfillment system 285 is coupled to output 280 to receive the output of computer server farm 260 and engage in corresponding fulfillment activities. Such fulfillment activities may include, but are not limited to, manufacturing, transportation, communications, financial transactions, securities trading, physical or data storage, and the like. Fulfillment system 285 may comprise a conventional computer-controlled mechanism, computer system, storage system, transportation device, communications system, payment system, securities trading system, or portion thereof, or the like. Based on output 280, fulfillment system 285 preferably engages in productive activities or triggers other systems to engage in such activities.

In alternate embodiments, the target average utility value provided by target average utility source 230 could be measured in units of time, currency, physical size, number of items, or the like. For example, in the case of a financial transaction involving goods, services, securities or the like, the available sales prices for a given number of units of goods, quantity (e.g., length of time) of services, or number of securities, etc., may be limited to specific levels. A rail car of goods may typically be less expensive on a per unit basis than a truckload of the same goods due to economies of scale. However, the availability of rail cars at a given time and location may be much less than the availability of trucks.

In the case of securities and other financial transactions, there is often a computational or practical limit to the precision with which prices can be expressed and traded. For example, fractions of a penny ($0.01) are difficult to address with physical pennies. Similarly, computational systems that trade using specific currency limits, e.g., tenths of a penny, may be ill-suited for trading in smaller units, e.g., hundredths or thousandths of a penny. The precision of a quoted price may be increased well beyond the precision available in the transactional system.

Typically, a buyer would like to minimize its cost in a transaction by obtaining the lowest price available for a given number of units (demand). Sellers offering units at the same price may be incentivized to differentiate their prices from competing sellers by increasing the precision of their sale price beyond the capability of the transactional system. For example, in a transactional system that operates with the precision of $0.01, if a single share of stock trades at $10.00 (bid/offer price) and $10.02 (ask/sale price), there is a $0.02 spread. Although the typical buyer would like to transact at a price less than $10.02 if a seller is willing to provide a lower price, the $0.01 precision limit of the transactional system inhibits efforts to trade at prices between $10.01 and $10.02. Such inhibition is due to the inherently limited precision (e.g., $0.01) of the transactional system.

There may be sellers that can offer some percentage of the spread to the buyer but are prevented from doing so due to the limited precision of the transactional system. Continuing with the above example, if a seller could offer 25% of the spread to improve the price shown to the buyer, the trade could happen at $10.015 if the precision of the transactional system allowed quotation in $0.005 amounts (five one thousandths of a penny). Where the precision of the transactional system is only $0.01, the seller is unable to present the improved price to the buyer directly in the transactional system.

In a preferred embodiment of the present invention, an additional transactional system is provided to receive a seller's price improvement, display the price improvement to prospective buyers, receive a buyer's acceptance of the price improvement, and then utilize the precision limited transactional system to transact units (shares) to obtain an average price per unit (price per share) equal to or near the seller's actual price improvement by splitting the buyer's purchase into two or more separate transactions at nearby, if not the nearest, available prices.

Again continuing the above example, the inventive system can implement the desired transaction at a more precise price by, for example, engaging in two transactions: one for a quantity of units (shares) at $10.01 and another for another quantity of units (shares) at $10.02, such that the average price is at or near the desired price improvement of $10.015. Again assuming that the transactional system was limited to price quotations in $0.01 amounts, a buyer desiring to buy 100 units (shares) could be advantageously matched with the seller offering a 25% price improvement facilitated by the additional system as two sales: 50 unites (shares) at $10.01 and 50 units (shares) at $10.02.

In a preferred embodiment described in connection with FIG. 2, the seller provides the exact price at which it is willing to sell as target average utility 230 of a particular quantity. The available sale prices in the market at different quantities are provided as computer A parameters 211 (e.g., $10.01) and computer B parameters 212 (e.g., $10.02). Alternatively, in a more simplified implementation, computer A parameters 211, computer B parameters 212, computer C parameters 213, and computer D parameters 214 are each the current market price for sales (e.g., $10.02) in a typical quantity. As a further alternative, the seller sets the target average utility 230 at a percentage of price improvement compared to current market price for sales it (or another entity) is offering via one or more of computer parameters 211, 212, 213, and 214.

A potential buyer communicates an interest in buying a specified quantity (e.g., 100 units/shares) at a best available price as demand 220. Alternatively, the buyer sets a particular price below the current market price provided by one of computer parameters 211, 212, 213, etc. Control system 240 determines that a transaction may be facilitated by matching the buyer with the seller willing to offer the lower price in target average utility 230. Control system 240 controls computer server farm 260 to implement the transaction by splitting it into two or more transactions implemented by computer A 271 or by a combination of one or more of computer A 271, computer B, 272, computer C 273 and/or computer D 274. For example, control system 240 may control computer server farm 260 to implement the transaction as two transaction: 50 unites (shares) at $10.01 and 50 units (shares) at $10.02.

Control system 240 facilitates reaching the target average utility amount (e.g., the more specific lower price) by solving a set of linear equations depending on the computer parameter(s), demand, and the target average utility values and, optionally, the number of transactions desired. In the example where computer server farm 260 can only transact in $0.01 amounts, the available prices to transact at below $10.02 would be in increments of $0.01, e.g., $10.01, $10.00, $9.99, . . . . System 240 selects the lower price at which to transact an appropriate volume, e.g., $10.01 and then solves the linear equations to implement the target average utility for the desired demand. If the market sale price is $10.02, the market purchase price is $10.00, the price improvement is 10% ($10.018), and the desired number of units (shares) is 100:

$$lower\_price \_size + market\_price \_size = 100$$

$$( lower\_price \_size * \$10 \text{.01} + market\_price \_size * \$10 \text{.02} ) / ( lower\_price \_size + market\_price \_size ) = \$10 \text{.018}$$

Solving for the two sizes results in:

$$lower\_price \_size = 20 shares$$

$$market\_price \_size = 80 shares$$

$$because ( ( 200.2 + 801.6 / 100 = 10.018 ) )$$

System 240 then directs computer server farm 260 to implement two transactions: 20 units/shares at $10.01 and 80 units/shares at $10.02. The actual implementation of the transactions may be achieved by computers within computer server farm 260 or by fulfillment system 285 as directed by computer server farm 260. Fulfillment system 285 may be implemented as one or more transactional systems, markets, exchanges, securities exchanges, commodities exchanges, alternative trading venues, or the like.

In a further alternate embodiment, System 240 may have the option to utilize lower available prices for the split transactions—e.g., $10.00. This may occur because of quantity limitations at different prices. Additionally, the completed transactions may be detected by output detector 290 for confirmation of execution with a signal indicating success and/or the specific of the completed transactions transmitted back to control system 240. If the completed transactions were insufficient to satisfy the demand 220 from the buyer, system 240 may try again to split the remaining transaction into smaller transactions at different prices to meet, or at least approach, the target average utility value.

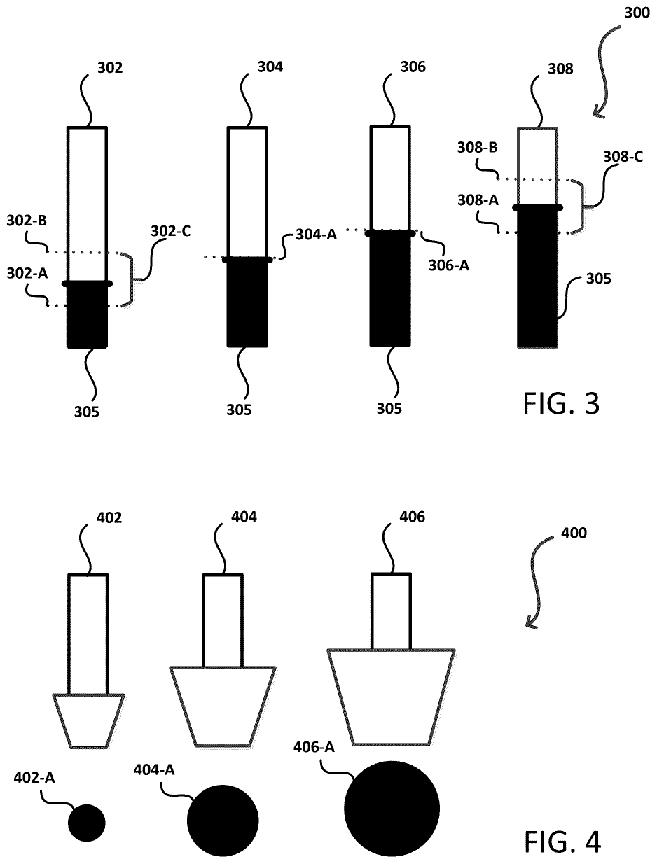

FIG. 3 shows a collection 300 of different positional scenarios for a mechanical piston pushing a feedstock. To push feedstock 302, piston 305 travels from position 302-A to position 302-B traversing a distance of 302-C. To push feedstock 304, piston 305 has reached position 304-A which is between positions 302-A and 302-B. In pushing feedstock 306, piston 305 has reached position 306-A which is higher than positions 304-A and 306-A. In pushing feedstock 308, piston 305 travels from position 308-A to position 308-B traversing a distance of 308-C where position 308-A is substantially the same as position 306-A and distance 308-C is substantially the same as distance 302-C.

As an example of the operation of system 100 of FIG. 1 controlling a single machine 170-1 comprising a piston 305, piston height 302-A corresponds to machine 1 parameter 110-1, piston height 304-A corresponds to machine 2 parameter 110-2, piston height 306-A corresponds to machine 3 parameter 110-3 (not shown), and piston height 308-A corresponds to machine 4 parameter 110-4. Given a demand of 100 units of feedstock, the availability of six different position heights 302-A, 302-B, 304-A, 306-A, 308-A, and 308-B, and a target piston average height of 306-A, the control system 140, implementing the calculation engine of the present invention, determines the allocation of piston heights for piston 305 to best achieve the target average piston height 306-A for supply the 100 units of feedstock.

FIG. 4 shows a manufacturing system 400 comprising three different ink jet printer heads: small printer head 402, medium printer head 404, and large printer head 406. As an example operation, small head 402 prints a small ink dot 402-A but clogs every 200 prints, medium head 404 prints a medium-sized ink dot 404-A but clogs every 400 prints, and large head 406 prints a large ink dot 406-A but clogs every 800 prints. The size of the ink dot and the clog rate correspond to the machine parameters 110-1, 110-2, and 110-3. Continuing the example, a demand for ink coverage 10 times the size of ink dot 406-A is required while the target average dot size (target average utility) is dot size 404-A. The system 100 determines the allocation of operation of each of printer heads 402, 404, and 406 to meet the demand for 10× the size of 406-A, achieve the target average dot size 404-A, and minimize downtime for clearing clogged print heads.

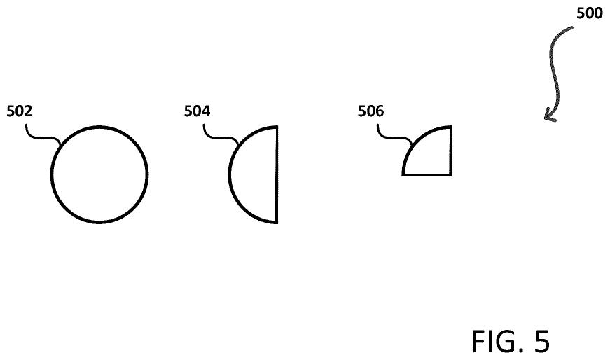

FIG. 5 shows a simplified example implementation of the present invention utilization the distribution of medication tablets. In system 500, three tablet portions are available: full tablet 502, half tablet 504 and quarter tablet 506. In this example, the demand is 50 tablets per month with a target average dosage of one-and-a-half tablets every day; however, the supply of full tablets, half tablets and quarter tablets changes each week. In other words, the system can only reliably know the availability of tablet supplies on a weekly basis. The system 100 determines the allocation of distribution of tablet portions for each day in a week based on the known supply for the week and the target average dosage. The system then recalculates the daily allocation each week to meet the monthly demand but still within the target average dosage.

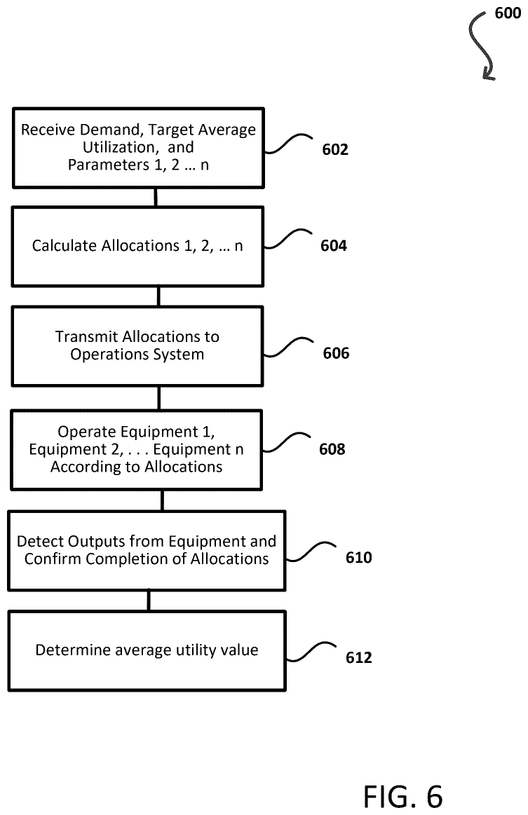

FIG. 6 shows a flow diagram 600 of a method for allocating resources using the embodiments described above in connection with system 100 and system 200. In step 602, the control system (e.g., industrial control system 140, control system 240, or the like) receives a demand value, a target average utility value, and an operational parameter for each item of equipment. In step 604, the control system calculates operating allocations for each item of equipment based on the received values and parameters. In step 606, the control system transmits the calculated allocations to the operational system (e.g., manufacturing system 160, computer server farm 260, or the like). In step 608, the operational system operates each of the items of equipment according to the allocations received. In step 610, the individual output of each item of equipment is detected. Optionally in step 610, the completion of the allocations is determined. In step 612, the average utility value is determined from the outputs each item of equipment.

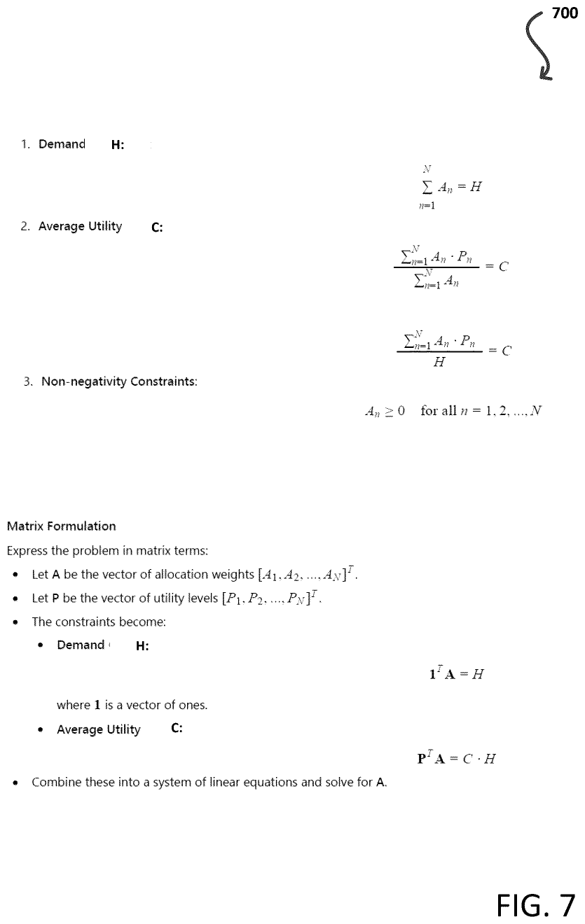

FIG. 7 shows an algorithm 700 for allocating resources. The demand value H is the sum of the operational allocations A₁, . . . , Aₙ for items of equipment n=1 to N, where Nis the total number of items of equipment. The operational parameter, e.g., utility level, for a particular item of equipment x is the value Pₓ. For an item of equipment x, the utility value Uₓ is its allocation Aₓ multiplied by its operational parameter Pₓ. The average utility value C for the group of equipment (e.g., manufacturing system 160, computer server farm 160, or the like), is the sum of the utility values (U₁+U₂+ . . . +U_{N}) for each item of equipment divided by the sum of the allocations (A₁+A₂+ . . . +A_{N}). The resulting number of linear equations, equal to the number of items of equipment, can be solved using conventional methods to determine each of allocations A₁, A₂, . . . , A_{N}.

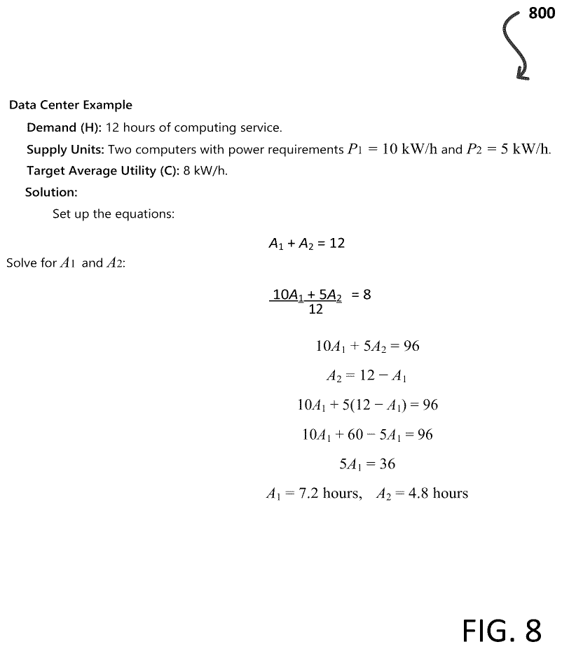

FIG. 8 provides a data center utilization example 800 implementing the algorithm of FIG. 7.

The various implementations disclosed above are applicable in many different and varied operating environments, and on one more electronic devices that incorporate integrated circuits, chips for processing and memory purposes. The proper configuration of hardware, software, and/or firmware is presently disclosed above to improve a computer's ability to interface with market data for trading. A system or method of the present disclosure also includes a number of the above exemplary systems working together to perform the same function disclosed herein.

Most of the exemplary implementations above utilize at least one communications network using one or more commercial communications protocols, such as TCP/IP, FTP, UPnP, NFS, and CIFS. The networks can be wireless or wired—including a local area network (LAN), a wide-area network (WAN), a virtual private network, the internet, an intranet, an extranet, a public switched telephone network, an infrared network, a wireless network and one or more of the above networks in a combination.

An example of the present invention can include a database formed from a variety of data stores and other memory or storage media. These components can reside in one or more of the servers, as discussed above, or may reside in a network of the servers. In certain embodiments, the information may reside in a storage-area network (SAN). Similarly, files for performing the functions attributed to the computers, servers or other network devices discussed above may be stored locally and/or remotely, as appropriate. Each computing system described above, including the client devices, may incorporate hardware elements that are electrically coupled via data/control/and power buses. For example, one or more processors in such computing systems may be central processing units (CPU) for one or more of the client devices. The client devices may further include at least one user device (e.g., a mouse, keyboard, controller, keypad, or touch-sensitive display) and at least one output device (e.g., a display, a printer or a speaker). Such client devices may also include one or more storage devices, including disk drives, optical storage devices and solid-state storage devices such as random access memory (RAM) or read-only memory (ROM), as well as removable media devices, memory cards, flash cards, etc.

The computer systems discussed above can also include computer-readable storage media reader, communications devices (e.g., modems, network cards (wireless or wired), or infrared communication devices) and memory, as previously described. The computer-readable storage media reader is connectable or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and other non-transitory computer readable media for containing code, or portions of code, can include any appropriate media known or used in the art, such as but not limited to volatile and non-volatile, removable and non-removable media implemented in any method or technology for storage of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth.

1. An operation resource allocation control system comprising:
a plurality of operation parameter data sources providing a respective plurality of operation parameter data;
an operation demand data source providing an operation demand data;
a target average utility data source providing a target average utility goal;
a control system, comprising an operation allocation calculation engine, coupled to said plurality of operation parameter data sources, said operation demand data source, and said target average utility data source;
an operation system, coupled to said control system and having a plurality of resource inputs and an operation output, comprising a plurality of operation units, wherein each operation unit has a respective operation rate;
a plurality of resources coupled to said plurality of resource inputs; and
an output detector coupled to said operation output and to said control system;
wherein said control system throttles the respective operation rates of said plurality of operation units to meet said target average utility goal, based on said plurality of operation parameter data, said operation demand data, and said target average utility goal.

2. The system of claim 1,
wherein said output detector detects an operation output of each of said plurality of operation units and provides an operation output data to said control system; and
wherein said control system throttles the respective operation rates based on said operation output data.

3. The system of claim 2, wherein said plurality of operation units comprise a machine with a valve piston and said control system controls the position of said valve piston.

4. The system of claim 2, wherein said plurality of operation units comprise a machine with a fluid dispenser and said control system controls the volume of fluid dispensed.

5. The system of claim 2, wherein said plurality of operation units comprise a machine with a material dispenser and said control system controls the number of units of materials dispensed.

6. An operation resource allocation control method comprises the steps of:
receiving a plurality of operation parameter data, an operation demand data, and a target average utility goal;
calculating a plurality of operation rate allocations to achieve said target average utility goal, based on said plurality of operation parameter data, said operation demand data, and said target average utility goal;
communicating, respectively, said plurality of operation rate allocations to a plurality of operation equipment;
operating each of said plurality of operation equipment in accordance with a respectively corresponding one of said plurality of operation rate allocations;
detecting a plurality of respective output values for said plurality of operation equipment;
determining an average utility value based on said plurality of respective output values.

7. The method of claim 6, further comprising the steps of:
adjusting said plurality of operation rate allocations based on said plurality of respective output values.

8. The method of claim 7, wherein said plurality of operation equipment comprises a machine with a valve piston and the step of operating comprises the step of controlling the position of said valve piston.

9. The method of claim 7, wherein said plurality of operation equipment comprises a machine with a fluid dispenser and the step of operating comprises the step of controlling the volume of fluid dispensed.

10. The method of claim 7, wherein said plurality of operation equipment comprises a machine with a material dispenser and the step of operating comprises the step of controlling the number of units of materials dispensed.
